(19) United States
(12) Patent Application Publication
(10) Pub. No.: US 2017/0350760 A1
(43) Pub. Date: Dec. 7, 2017

(54) Optical measurement system

(71) Applicant: Spectral Engines Oy, Helsinki (FI)

(72) Inventors: Jarkko Antila, Helsinki (FI); Uula Kantojärvi, Helsinki (FI); Jussi Mäkynen, Helsinki (FI)

(73) Assignee: Spectral Engines Oy, Helsinki (FI)

(21) Appl. No.: 15/524,628

(22) PCT Filed: Nov. 5, 2015
(86) PCT No.: PCT/FI2015/050765

§ 371 Date: May 5, 2017

(30) Foreign Application Priority Data
Nov. 6, 2014 (FI) 20145969

(51) Int. Cl. G01J 3/26; G01J 3/02

(52) U.S. Cl. CPC G01J 3/26; G01J 3/0286

(57) ABSTRACT

The present invention concerns an optical measurement system comprising an electrically tunable Peltier element, a detector for detecting radiation from a radiation source in a measurement area, the detector being in thermal connection with the Peltier element, an electrically tunable Fabry-Perot interferometer placed in the path of the radiation prior to the detector, the Fabry-Perot interferometer being in thermal connection with the Peltier element, and control electronics circuitry configured to control the Peltier element, the interferometer, and the detector. The present invention further concerns a method for analyzing the spectrum of an object.

### TECHNICAL FIELD OF THE INVENTION

The present invention relates to an optical measurement system. In particular, the present invention relates to a spectrometer for optical measurement including a Fabry-Perot interferometer and a detector. The present invention further relates to a method for analyzing the spectrum of an object. The present invention furthermore relates to a computer readable medium having stored thereon a set of computer implementable instructions.

### BACKGROUND OF THE INVENTION

Optical measurement systems are e.g. used for analyzing properties or material contents of a target. The spectrum of an object, for example a gas or gas mixture, can be measured by using spectrometer comprising a Fabry-Perot interferometer and a detector for monitoring intensity of light transmitted through the Fabry-Perot interferometer. Use of micromechanical technology for producing Fabry-Perot interferometers is common.

A Fabry-Perot interferometer is based on two mirrors, i.e. an input mirror and an output mirror arranged facing the input mirror via a gap. In this document a “mirror” is a structure where there is a layer or a set of layers which reflects light. The pass band wavelength can be controlled by adjusting the distance between the mirrors, i.e. the width of the gap. The Fabry-Perot interferometer may provide a narrow transmission peak, which has adjustable spectral position, and which can be used for spectral analysis. A spectrometer may provide a control signal indicative of the mirror gap. The control signal may be provided e.g. by a control unit, and the mirror gap may be controlled according to the control signal. Alternatively, the control signal may be provided by monitoring the mirror gap, e.g. by using a capacitive sensor. The control signal may be e.g. a digital control signal or an analog control signal. Each spectral position may be associated with a control signal.

The relationship between each spectral position of the transmission peak and a control signal value corresponding to said spectral position may depend e.g. on the operating temperature of the Fabry-Perot interferometer. As changes of temperature of the environment typically affect the operating temperature of the interferometer, temperature drift will occur in the wavelength response of the interferometer. The width of the gap of the interferometer may, for example, change by 1 [nm/° C.]. Instead, maximum tolerance values in some technical measurements allow only changes of the width of the gap of less than 0.05 [nm/° C.].

Document U.S. Pat. No. 5,818,586 describes that a miniaturized spectrometer for gas concentration measurement includes a radiation source for admitting electromagnetic radiation onto the gas to be measured, a detector for detecting the radiation transmitted through or emitted from the gas, an electrically tunable Fabry-Perot interferometer placed in the path of the radiation prior to the detector, control electronics circuitry for controlling the radiation source, the interferometer and the detector. The radiation source, the detector, the interferometer and the control electronics are integrated in a miniaturized fashion onto a common, planar substrate and the radiation source is an electrically modulatable micromechanically manufactured thermal radiation emitter.

Document US 2013/0329232 A1 further discloses controllable Fabry-Perot interferometers which are produced with micromechanical (MEMS) technology. According to the invention the interferometer arrangement has both an electrically tunable interferometer and a reference interferometer on the same substrate. The temperature drift is measured with the reference interferometer and this information is used for compensating the measurement with the tunable interferometer.

### SUMMARY OF THE INVENTION

An object of certain embodiments of the present invention is to provide an optical measurement system. In particular, an object of certain embodiments is to provide an optical measurement system including a Fabry-Perot interferometer and a detector. Another object of certain embodiments of the present invention is to provide a method for analyzing the spectrum of an object. It is also an object of certain embodiments of the present invention to provide a computer readable medium having stored thereon a set of computer implementable instructions.

These and other objects are achieved by embodiments of the present invention, as hereinafter described and claimed. According to an aspect of the invention, there is provided an optical measurement system comprising:
an electrically tunable Peltier element,
a detector for detecting radiation from a radiation source in a measurement area, the detector being in thermal connection with the Peltier element,
an electrically tunable Fabry-Perot interferometer placed in the path of the radiation prior to the detector, the Fabry-Perot interferometer being in thermal connection with the Peltier element, and
control electronics circuitry configured to control the Peltier element, the interferometer, and the detector.

According to an embodiment, the Peltier element is configured to control a temperature of the interferometer. According to an embodiment, the Peltier element is further configured to control the temperature of the interferometer such that the temperature remains essentially constant. According to another embodiment, the Peltier element is configured to control a temperature of the detector.

In an embodiment, the Peltier element, the detector, and the interferometer are arranged in a cavity located in a housing or a cavity located in a cased structure. In another embodiment, the Peltier element is configured to control a temperature in the cavity. According to an embodiment, the Peltier element is further configured to control the temperature in the cavity such that the temperature remains essentially constant. The Peltier element is attached to a frame which is removably connected to the housing. The housing comprises cooling fins in order to increase the surface area of the housing for optimum heat transfer.

In an embodiment, the system includes at least one circuit board.

In another embodiment, the system comprises one or more than one thermistor.

According to another aspect, the object of the embodiments of the invention can be also achieved by a method for analyzing the spectrum of an object, the method comprising:
placing an electrically tunable Fabry-Perot interferometer in the path of a radiation emitted by a radiation source in a measurement area,
detecting the radiation by means of a detector,
controlling an electrically tunable Peltier element which is in thermal connection with the detector and/or interferometer.

According to an embodiment, the effect of a change in temperature of an environment on mechanical dimensions of the interferometer is essentially compensated by means of the Peltier element.

According to another embodiment, the Peltier element is controlled such that a temperature of the detector or the interferometer remains essentially constant.

In an embodiment, the system comprises a filter configured such that a bandwidth of wavelengths can pass the filter. In another embodiment, the bandwidth of wavelengths is a main bandwidth of wavelengths of the Fabry-Perot interferometer. Typically, the bandwidth of wavelengths is in the wavelength range between λ=1 [μm] and λ=2 [μm], λ=1 [μm] and λ=5 [μm], or λ=1 [μm] and λ=10 [μm].

Additionally, according to another aspect, the object of the embodiments of the invention can be also achieved by a computer readable medium having stored thereon a set of computer implementable instructions capable of causing a processor, in connection with the optical measurement system according to any one of claims 1 to 15, to analyze properties or material contents of a radiation source in a measurement area.

Considerable advantages are obtained by means of the embodiments of the present invention. Embodiments of the invention provide an optical measurement system. In particular, certain embodiments provide an optical measurement system including a Fabry-Perot interferometer and a detector. Certain embodiments provide a method for analyzing the spectrum of an object, for example such as a gas or a gas mixture or a liquid. Additionally certain embodiments provide a computer readable medium having stored thereon a set of computer implementable instructions.

According to the embodiments of the present invention, it is possible to achieve high temperature stability since the effect of changes in temperature of the environment on the dimensions of the Fabry-Perot interferometer and/or detector can be compensated to large extent by means of the Peltier element. Changes of the width of the gap of less than 0.05 [nm/° C.] during operation of the optical measurement system can be realized by means of the embodiments of the invention. At the same time, the operational temperature range, i.e. the temperature range of the environment, may be according to a specific embodiment between −10 [° C.] and +70 [° C.], i.e. the temperature of the interferometer and/or detector can be held essentially constant in said operational range. According to certain other embodiments, the operational temperature range may be between +10 [° C.] and +30 [° C.], or between −20 [° C.] and +40 [° C.], for instance. According to a certain embodiment, a temperature of the environment in the range between about 65 [° C.] and 70 [° C.] can be compensated by means of the Peltier element. In this case, the temperature of the Peltier element may be 40 [° C.]±0.05 [° C.]. The power of the optical measurement system is typically less than 1 [W], i.e. power consumption of the system according to the specific embodiment of the present invention is low compared to existing spectrometers operating in a temperature range between 65 [° C.] and +70 [° C.]. Additionally, the structure of the housing and frame according to certain embodiments, i.e. cooling fins and/or wedge shaped portions of the housing as well as form fitting wedge shaped portions of the frame highly support heat exchange. Suprisingly, the measurement by the detector, which is located between the Peltier element and the Fabry-Perot interferometer, is not affected during controlling of the temperature of the interferometer. The system can be adjusted for several temperature ranges by measuring the temperature of the environment and wavelength calibration of the device. Temperature ranges can automatically change and thermal operation can be improved.

The embodiments of the present invention provide a simple and compact structure. An additional reference interferometer is not required, thus reducing costs and production time as well as avoiding problems resulting from calibration of two interferometers. The measurement accuracy and stability can be improved and requirements for packaging are lighter.

### BRIEF DESCRIPTION OF THE DRAWINGS

For a more complete understanding of particular embodiments of the present invention and their advantages, reference is now made to the following descriptions, taken in conjunction with the accompanying drawings. In the drawings:

FIG. 1 illustrates a schematic view of a frame of an optical measurement system according to a first embodiment of the present invention,

FIG. 2 illustrates a schematic perspective view of a portion of a frame of an optical measurement system according to a second embodiment of the present invention,

FIG. 3 illustrates a schematic perspective view of a second transversal element of a frame of an optical measurement system according to a third embodiment of the present invention,

FIG. 4 illustrates a schematic perspective view of a plug to be inserted into a frame of an optical measurement system according to a fourth embodiment of the present invention,

FIG. 5 illustrates a schematic cross sectional view of a plug including a spherical lens of an optical measurement system according to a fifth embodiment of the present invention,

FIG. 6 illustrates a schematic side view of a cased structure including a Fabry-Perot interferometer, detector, and Peltier element to be inserted into a frame of an optical measurement system according to a sixth embodiment of the present invention,

FIG. 7 illustrates a schematic top view of a portion of a housing of an optical measurement system according to a seventh embodiment of the present invention,

FIG. 8 illustrates a schematic perspective view of a portion of a housing of an optical measurement system according to an eighth embodiment of the present invention,

FIG. 9 illustrates a schematic front view of a portion of an optical measurement system according to a ninth embodiment of the present invention,

FIG. 10 illustrates a schematic front view of an optical measurement system according to a tenth embodiment of the present invention,

FIG. 11 illustrates a schematic perspective view of an optical measurement system according to an eleventh embodiment of the present invention,

FIG. 12 illustrates a schematic view of an optical measurement system according to a twelfth embodiment of the present invention, and

FIG. 13 illustrates schematic a flow chart of a method for analyzing the spectrum of an object according to a thirteenth embodiment of the present invention.

### DETAILED DESCRIPTION OF EMBODIMENTS OF THE INVENTION

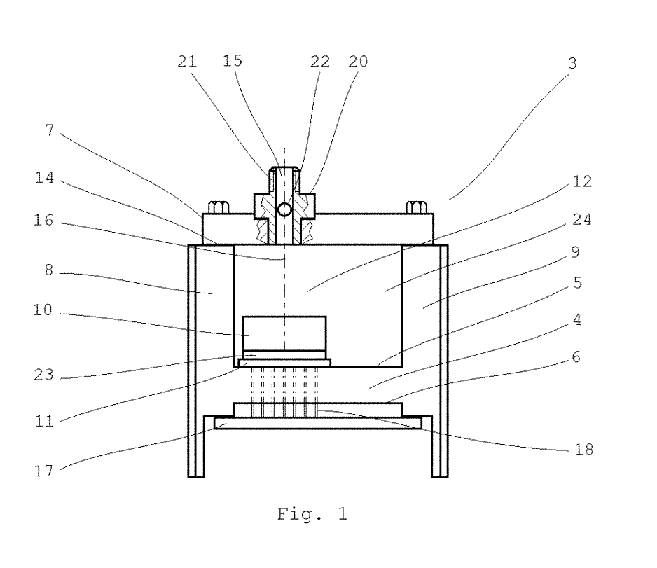

In FIG. 1 a schematic view of a frame 3 of an optical measurement system 1 according to a first embodiment of the present invention is illustrated. The frame 3 includes a first longitudinal element 8 and a second longitudinal element 9 which is separated from the first longitudinal element 8 by a first transversal element 4. On a first side 5 of the first transversal element 4 an electrically tunable Peltier element 11 is fixedly attached. Electrical wires 18 are guided from the Peltier element 11 through the first transversal element 4 to a circuit board 17 which is located on the second side 6 of the first transversal element 4. By means of the Peltier element 11 it is possible to transfer heat from one side of the first transversal 4 element to the other, with consumption of electrical energy, depending on the direction of the current. The Peltier element 11 can be used as a temperature controller that either heats or cools.

A detector 23 for detecting radiation from a radiation source 24 in a measurement area 25 is fixedly attached to the Peltier element 11. Additionally, an electrically tunable Fabry-Perot interferometer 10 is placed in the path of the radiation prior to the detector 23. According to certain embodiments, the Fabry-Perot interferometer 10, the detector 23, and the Peltier element 11 may be arranged in a cased structure 36 which is not shown in FIG. 1.

Further, a second transversal element 7 is attached to the first and second longitudinal elements 8, 9 of the frame 3 by means of screws and/or adhesive 14. A cover plate 24 is additionally attached to the first and second longitudinal elements 8, 9 and the first transversal element 4. The first and second longitudinal elements 8, 9, the first transversal element 4 and the cover plate 24 may be, for example, milled from a solid piece of metal.

The first and second longitudinal elements 8, 9, the first and second transversal elements 4, 7, and the cover plate 24 form a frame 3 having a cavity 12 which is open to one side. The frame 3 is configured to be inserted into a housing 2 of the measurement system 1, which housing 2 is not shown in FIG. 1. A plug 20 comprising a channel 15 is inserted into the second transversal element 7 in order to provide a channel 15 for radiation from outside the cavity 3 to inside the cavity 3. In other words, a predetermined radiation path 16 is created. In the channel 15 a lens 22 is arranged.

The Peltier element 11, the detector 23, and the interferometer 10 are arranged in the cavity 12 of the frame 3. According to the embodiments, the Peltier element 11 is configured to control a temperature of the interferometer 10. According to certain embodiments, the Peltier element 11 is configured to control a temperature of the detector 23. According to other certain embodiments, the Peltier element 11 is configured to control a temperature in the cavity 12. In this case, the Peltier 11 element is, for example, configured to control the temperature in the cavity 12 such that the temperature remains essentially constant.

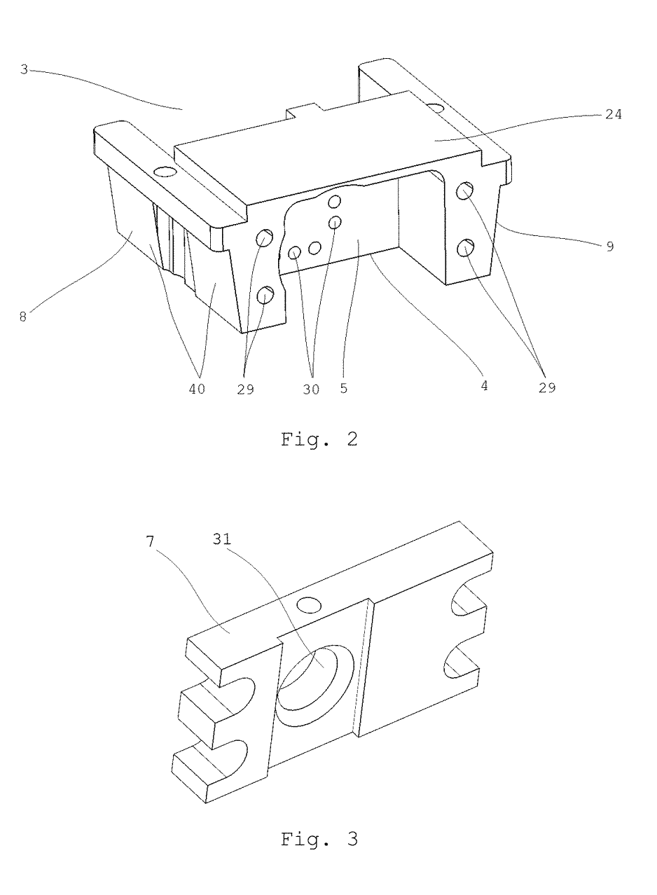

In FIG. 2 illustrates a schematic perspective view of a portion of a frame 3 of an optical measurement system 1 according to a second embodiment of the present invention is illustrated. A second transversal element 7 attached to the first and second longitudinal element 8, 9 is not shown in the figure. The second transversal element 7 may be, for example, attached to the first and second longitudinal element 8, 9 by means of an adhesive. According to certain embodiments, it is also possible to attach the second transversal element 7 to the first and second longitudinal element 8, 9 by screws in borings 29. According to certain other embodiments, the second transversal element 7 may be attached to the first and second longitudinal element by welding, for example by laser welding. Attachment of the second transversal element to the first and second longitudinal element 8, 9 results in forming a cavity 12. The portion of the frame 3 further includes openings 30 through the first transversal element 4 for guiding electrical wiring 18 of the Fabry-Perot interferometer 10, the detector 23, and the Peltier element 11 from the first side 5 of the first transversal element 4 to the second side 6 of the first transversal element 4. The first and second longitudinal elements 8, 9 further comprise wedge shaped portions 40 for maximizing the area of heat transfer contact surfaces of the frame 3.

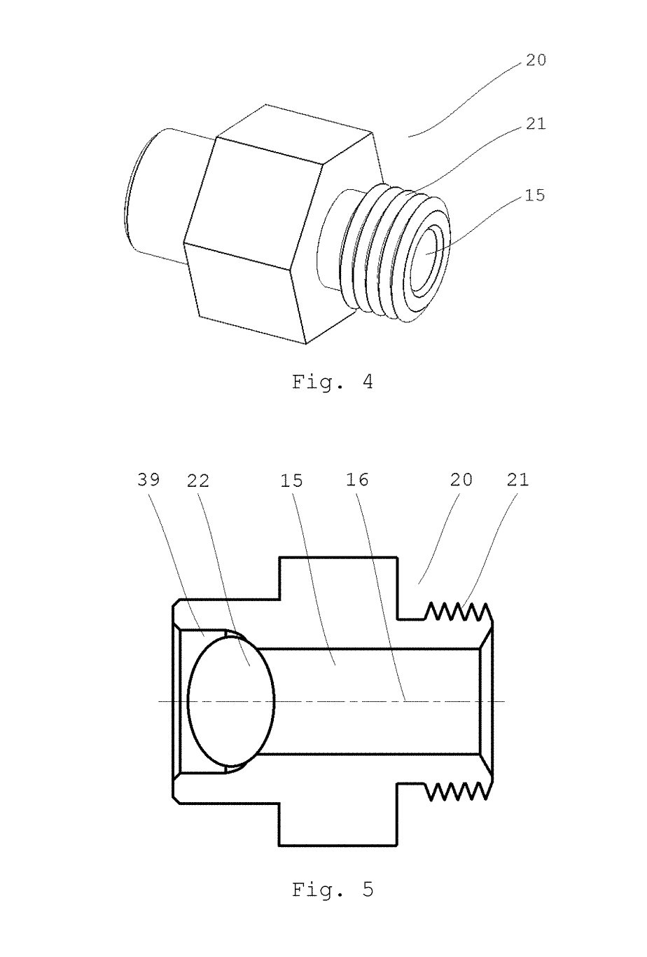

In FIG. 3 a schematic perspective view of a second transversal element 7 of a frame 3 of an optical measurement system 1 according to a third embodiment of the present invention is illustrated. The second transversal element 7 includes an opening 31 for insertion of a plug 20. The second transversal element 7 is configured to be attached to the first and second longitudinal element 8, 9 by means of adhesive and screws.

In FIG. 4 a schematic perspective view of a plug 20 to be inserted into a frame 3 of an optical measurement system 1 according to a fourth embodiment of the present invention is illustrated. The plug 20 comprises a channel 15 to be inserted into the second transversal element 7. The plug 20 provides a channel 15 for radiation from outside the cavity 3 to inside the cavity 3. In the channel 15 a lens 22 is arranged. The plug 20 further comprises a thread 21 for attachment of an optical fiber which is to be directed to a radiant source 25 in a measurement area 26.

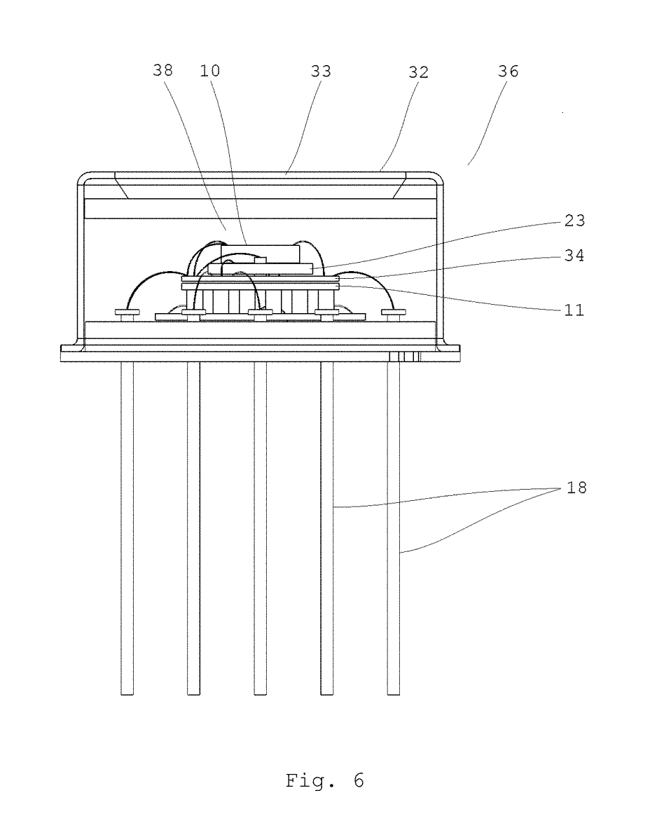

In FIG. 5 a schematic cross sectional view of a plug 20 including a spherical lens 22 of an optical measurement system 1 according to a fifth embodiment of the present invention is illustrated. The plug 20 comprises a recess 39 on the side to be inserted into the second transversal element 7. In the path of radiation 16 a lens 22 is arranged. The lens 22 may be, for example, a spherical lens, an elliptical lens, or a lens having any other suitable lens form.

In FIG. 6 a schematic side view of a cased structure 36 including a Fabry-Perot interferometer 10, a detector 23, and a one-phase Peltier element 11 to be inserted into a frame 3 of an optical measurement system 1 according to a sixth embodiment of the present invention is illustrated.

Radiation can enter the hermetically sealed cased structure 36 shown through an aperture 32 in which a filter 33 is arranged. The filter 33 is configured such that only a certain bandwidth of wavelengths λ can pass the filter. The bandwidth of wavelengths λ may be, for example, the main bandwidth of the Fabry-Perot interferometer 10. The wavelength range may be, for example, between α=1 [μm] and α=2 [μm]. According to certain other embodiments, the wavelength range may be, for example, between λ=1 [μm] and λ=5 [μm], or λ=1 [μm] and λ=10 [μm]. According to some embodiments, the filter 33 is tuned to a fixed wavelength.

Subsequently, the radiation passes the Fabry-Perot interferometer 10 and is then detected by means of the detector 23. The electrically tunable Fabry-Perot interferometer 10 comprises a first semi-transparent mirror and a second semi-transparent mirror, which are arranged to form an optical cavity of the interferometer. According to certain embodiments, the maximum change of the width of the gap is less than 0.2 [nm/° C.], less than 0.1 [nm/° C.], or less than 0.05 [nm/° C.] during operation of the optical measurement system 1. The Fabry-Perot interferometer may provide a narrow transmission peak, which has adjustable spectral position, and which can be used for spectral analysis. The spectral position of the transmission peak may be changed by changing the distance between the mirrors. The Fabry-Perot interferometer 10 may have an adjustable mirror gap. The spectral position of the transmittance peak may be changed according to the control signal. The control signal may be e.g. a voltage signal, which is applied to a piezoelectric actuator of the Fabry-Perot interferometer 10 in order to change the mirror gap of the Fabry-Perot interferometer. The control signal may be e.g. a voltage signal, which is applied to electrodes of an electrostatic actuator in order to change the mirror gap of the Fabry-Perot interferometer 10.

The detector 23, for example an infrared-detector, may comprise a spacer in order to arrange the detector 23 at a specific distance from the Fabry-Perot interferometer 10. According to certain embodiments, materials of components used in the cased structure 36 or located adjacent to each other have the same coefficient of thermal expansion or at least a coefficient of same order. The spacer may be, for example, made from silicon based on ceramic material. Typically, the detector 23 is configured to detect the filtered wavelengths. According to certain embodiments, the detector 23 is configured to detect at least the bandwidth of wavelengths of the Fabry-Perot interferometer 10. Since the noise level of an infrared-detector increases with increasing temperature, the temperature of the detector is stabilized to an accuracy of less than 0.5 [° C.], less than 0.3 [° C.], less than 0.1 [° C.], or less than 0.05 [° C.] according to certain embodiments.

Further, a submount 34 is arranged between the detector 23 and the Peltier element 11. The submount 34 may be, for example, made from ceramic material.

The Peltier element is configured to control the temperature T₂ of the interferometer 10. According to a certain embodiment, the Peltier element is controlled such that the temperature T₂ of the interferometer 10 remains essentially constant. An essentially constant temperature according to the present invention means that the temperature does not change more than 1 [° C.], preferably not more than 0.5 [° C.], even more preferably not more than 0.1 [° C.], or more than 0.05 [° C.]. In this case, the temperature T₂ of the interferometer 10 may be, for example, T₂=20 [° C.], T₂=22 [° C.], T₂=24 [° C.], T₂=38 [° C.], T₂=40 [° C.], T₂=42 [° C.], or any other predetermined temperature. According to certain other embodiments, the temperature of the interferometer 10 may vary in a specific range, for example between T₂=22.8 [° C.] and T₂=23.2 [° C.], or between T₂=39.95 [° C.] and T₂=40.05 [° C.]. In a certain embodiment, the Peltier element is configured to control the temperature of the cavity 38 in the cased structure 36.

The cased structure 36 may be fixedly attached to the first transversal element 4 of the frame 3 by means of use of an adhesive such as a thermally conductive adhesive, for example an epoxy, and simultaneous alignment. Heat exchange from inside the cavity 38 of the cased structure to outside the cavity 38 is effective without deformation of the cased structure 36 due to temperature change. The adhesive used may be flexible according to certain embodiments. In other cases, the cased structure 36 may be welded to the frame 3. Typically, only the surface of the cased structure 36 which is situated on the opposite side of the aperture 32 is connected to the frame 3 in order to avoid a heat return flow into the cased structure 36. Additionally, the Fabry-Perot interferometer 10, the detector 23, and the Peltier element 11 are connected to electric wires 18 which can be guided through openings 30 from the first side 5 of the first transversal element 4 to the second side 6 of the first transversal element 4. According to certain embodiments, one or more thermistors are arranged in the cased structure 36 for monitoring a temperature gradient in the cased structure 36. Arrangement of, for example, two thermistors improves the capability to stabilize the temperature T₂ of the interferometer 10.

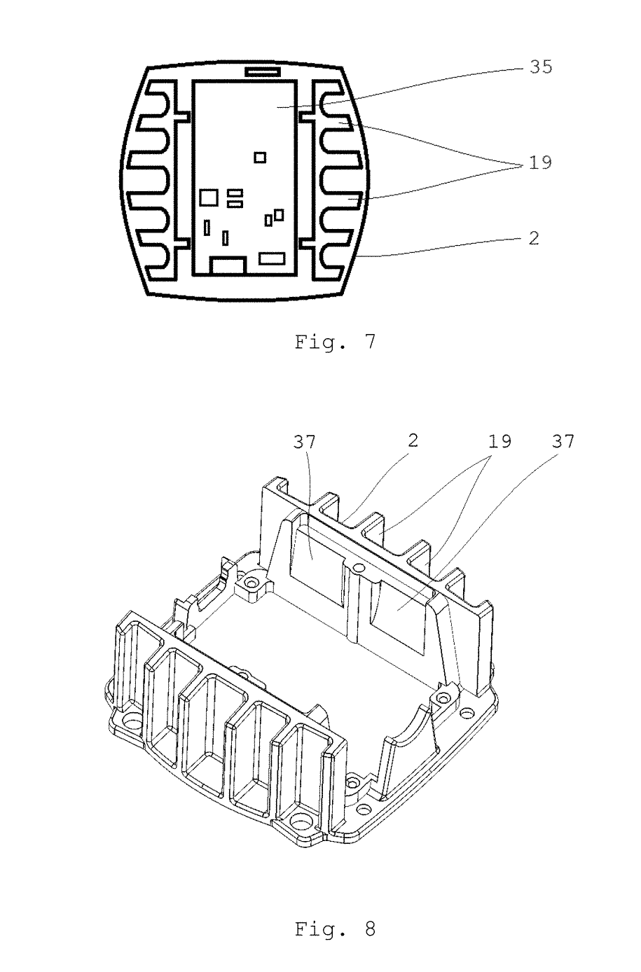

In FIG. 7 a schematic top view of a portion of a housing 2 of an optical measurement system 1 according to a seventh embodiment of the present invention is illustrated. The housing 2 comprises cooling fins 19 in order to increase the surface area of the housing 2 for optimum heat transfer. The cooling fins 19 extend from the housing 2 to increase the rate of heat transfer to or from the environment. The cooling fins 19 can be considered as an economical solution to heat transfer problems arising in the optical measurement system 1. In addition to the Peltier element 11 attached to the frame 3, which is not shown in FIG. 6, it is possible by means of the cooling fins 19 to reduce the dimensions of the optical measurement system 1 and to provide a simple and compact structure. The housing 2 also comprises a cover in order to create a closed cavity inside the housing, which cover is also not shown in FIG. 6.

According to certain embodiments, a main circuit board 35 is attached to the housing 2. The main circuit board 35 is connected to the circuit board 17 attached to the frame 3 by electrical wires. The main circuit board 35, the circuit board 17, and the electrical wires 18 connected to the Peltier element 11, the detector 23 as well as the Fabry-Perot interferometer 10 form a control electronics circuitry for controlling the Peltier element 11, the interferometer 10, and the detector 23.

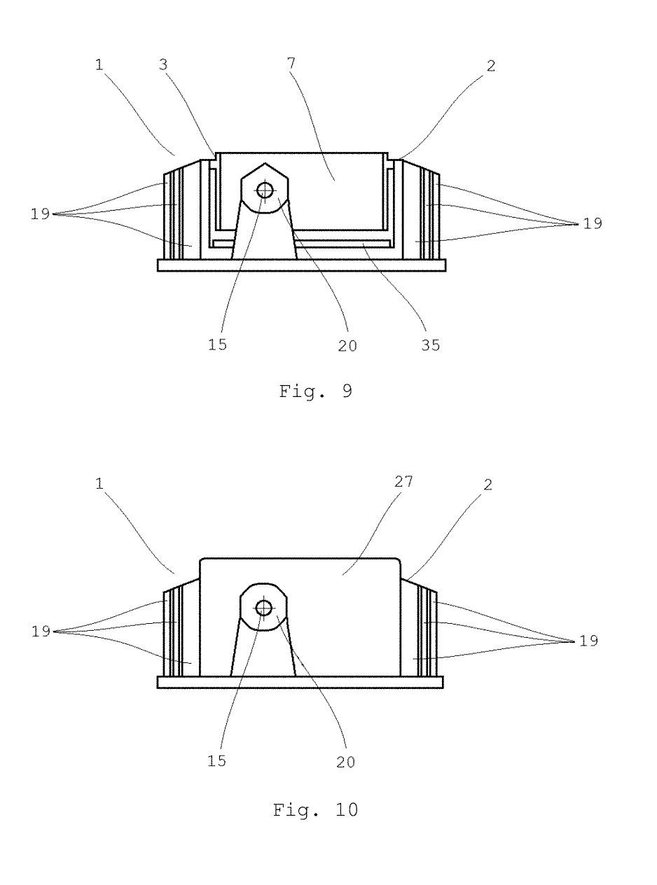

In FIG. 8 a schematic perspective view of a portion of a housing 2 of an optical measurement system 1 according to an eighth embodiment of the present invention is illustrated. The housing 2 is configured such that a frame 3 is to be inserted into the housing 2. The housing 2 includes wedge shaped portions 37 and the corresponding frame 3 to be inserted into the housing 2 also includes wedge shaped portions 40 which coincide with the wedge shaped portions 37 of the housing 2. The form fitting of the wedge shaped portions 37, 40 of the frame 3 and the housing 2 provide a maximum temperature range around a desired measurement temperature with minimum power consumption. Arrangement of wedge shaped portions 37 of the housing 2 and wedge shaped portions 40 of the frame 3 increases the area of the contact surface between the housing 2 and the frame 3 for optimum hear transfer. According to certain embodiments, the housing 2 is also configured such that a main circuit board 35 is to be attached to the housing 2.

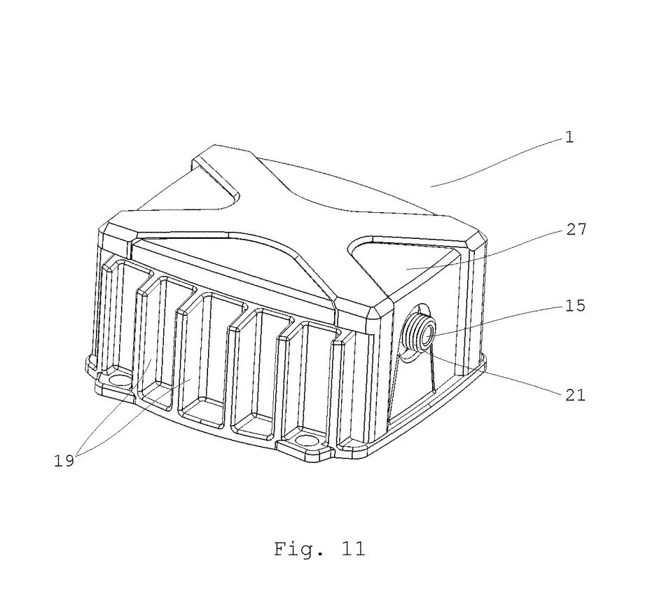

In FIG. 9 a schematic front view of an optical measurement system 1 according to a ninth embodiment of the present invention is illustrated. The frame 3 is inserted into the housing 2. A gap is arranged between the main circuit board 35 and the frame 3 in order to avoid damaging the main circuit board due to physical contact with the frame 3 or due to heat. During operation of the optical measurement system 1 the housing is closed by an additional cover of the housing 2, which cover is not shown in FIG. 8. A change in temperature T₁ of the environment surrounding the housing 2 on the dimensions of the interferometer 10 can be in particular compensated by means of the Peltier element 11 arranged in the cavity 12. Optimum heat transfer between the cavity 12 located in the housing 2 and/or the cavity 38 located in the cased structure 36 and the environment can be achieved by the cooling fins 19 as well as the wedge shaped portions 37 of the housing 2 and the wedge shaped portions 40 of the frame 3.

In FIG. 10 a schematic front view of an optical measurement system 1 according to a tenth embodiment of the present invention is illustrated. The housing 2 is closed by means of the cover 27, thus creating a cavity inside the housing 2. The temperature T₂ of the interferometer can be controlled with the Peltier element 11 and the cooling fins 19 depending on the temperature of the environment T₁.

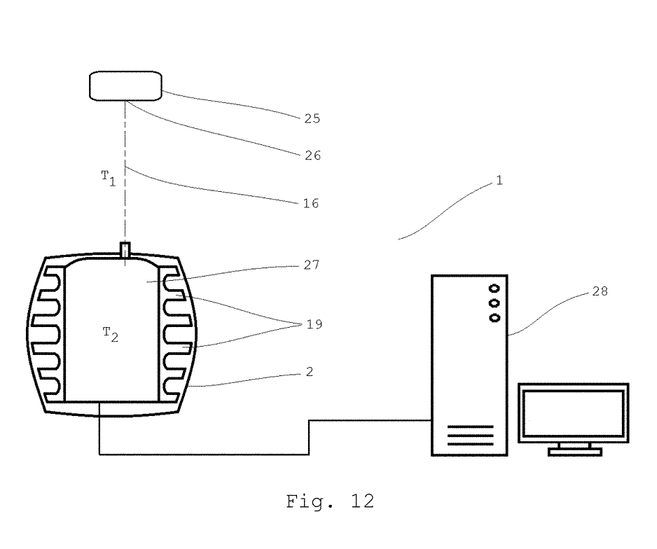

In FIG. 11 a schematic perspective view of an optical measurement system 1 according to an eleventh embodiment of the present invention is illustrated. The power of the optical measurement system 1 is typically less than 1 [W]. According to certain embodiments, the power of the optical measurement system is 1 [W] or more than 1 [W].

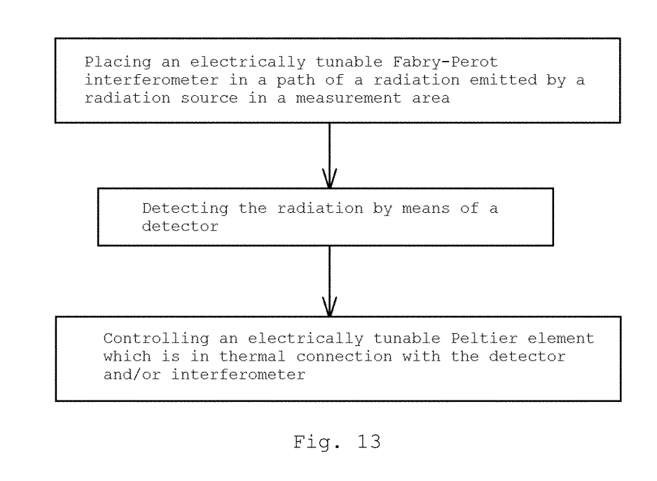

In FIG. 12 a schematic view of an optical measurement system according to a twelfth embodiment of the present invention is illustrated. The optical measurement system 1 is used for analyzing properties or material contents of a radiation source 25 in an environment. The temperature T₁ of the environment may be, for example, T₁=26 [° C.] and the temperature T₂ of the interferometer 10 may be, for example, T₂=22 [° C.], i.e. the temperature difference is □T=T₁−T₂=4 [° C.]. Due to the Peltier element 11, the cooling fins 19, and the wedge shaped portions 37, 40 of the housing 2 and the frame 3 the temperature T₁ of the environment does not affect the temperature T₂ of the interferometer 10, thus providing exact measurement results as the dimensions of the mirrors of the interferometer 10 do not change. Heat is transferred from inside the cavity 12 where the interferometer 10 is located to outside the cavity 12. According to certain embodiments, the operational temperature range, i.e. the temperature range of the environment, may be between T₁=−10 [° C.] and T₁=+70 [° C.], for instance. According to certain other embodiments, the operational temperature range may be between T₁=+10 [° C.] and T₁=+30 [° C.], or between T₁=−20 [° C.] and T₁=+40 [° C.], for instance. According to a certain embodiment, a temperature of the environment in the range between 65 [° C.] and 70 [° C.] can be compensated by means of the Peltier element. In this case, the temperature of the Peltier element may be, for example, 40 [° C.]±0.05 [° C.]. The temperature of the Peltier element can be adjusted by means of a software depending on the temperature or temperature range of the environment. The software typically includes calibrated values for certain temperature ranges of the environment in order to allow changes between preset programs automatically. According to an embodiment, the software is implemented in the optical measurement system 1.

According to certain other embodiments, the optical measurement system 1 further includes a computerized device 28, such as a personal computer or a mobile computing device, which is connected to the main circuit board 18. The computing device 28 includes a computer readable medium having stored thereon a set of computer implementable instructions capable of causing a processor, in connection with the optical measurement system 1, to analyze properties or material contents of the radiation source 25 in the measurement area 26.

In FIG. 13 a schematic flow chart of a method for analyzing the spectrum of an object according to a thirteenth embodiment of the present invention is illustrated. Firstly, an electrically tunable Fabry-Perot interferometer is placed in a path of a radiation emitted by a radiation source in a measurement area. Secondly, the radiation is detected by means of a detector. Subsequently, an electrically tunable Peltier element is controlled which is in thermal connection with the detector and/or interferometer.

According to a certain embodiment, the effect of a change in temperature of an environment on mechanical dimensions of the interferometer is compensated by means of the Peltier element. According to another certain embodiment, the Peltier element is controlled such that a temperature of the detector and/or the interferometer remains essentially constant.

Of course, the electrically tunable Peltier element can be controlled before placing the electrically tunable Fabry-Perot interferometer in the path of the radiation emitted by the radiation source in the measurement area or before detecting the radiation by means of a detector.

Although the present invention has been described in detail for the purpose of illustration, various changes and modifications can be made within the scope of the claims. In addition, it is to be understood that the present disclosure contemplates that, to the extent possible, one or more features of any embodiment may be combined with one or more features of any other embodiment.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### LIST OF REFERENCE NUMBERS:

1 optical measurement system
2 housing
3 frame
4 first transversal element
5 first side of first transversal element
6 second side of first transversal element
7 second transversal element
8 first longitudinal element
9 second longitudinal element
10 Fabry-perot interferometer
11 Peltier element
12 cavity
13 attachment area
14 adhesive
15 channel
16 radiation path
17 circuit board
18 electric wiring
19 cooling fins
20 plug
21 thread
22 lens
23 detector
24 cover plate
25 radiation source
26 measurement area
27 cover
28 computerized device
29 boring for screw
30 opening for electric wires
31 opening for plug
32 aperture
33 filter
34 submount
35 main circuit board
36 cased structure
37 wedge shaped portion of housing
38 cavity in cased structure
39 recess
40 wedge shaped portion of frame
T₁ temperature of environment
T₂ temperature of interferometer
□T temperature difference
λ wavelength

1. An optical measurement system comprising:
an electrically tunable Peltier element;
a detector for detecting radiation from a radiation source in a measurement area, the detector being in thermal connection with the Peltier element,
an electrically tunable Fabry-Perot interferometer placed in the path of the radiation prior to the detector, the Fabry-Perot interferometer being in thermal connection with the Peltier element and
control electronics circuitry configured to control the Peltier element, the interferometer, and the detector.

2. The optical measurement system according to claim 1, wherein the Peltier element is is configured to control a temperature of the interferometer.

3. The optical measurement system according to claim 1, wherein the Peltier element is configured to control a temperature of the interferometer such that the temperature remains essentially constant.

4. The optical measurement system according to claim 1, wherein the Peltier element is configured to control a temperature of the detector.

5. The optical measurement system according to claim 1, wherein the Peltier element, the detector, and the interferometer are arranged in a cavity located in a housing or a cavity located in a cased structure.

6. The optical measurement system according to claim 5, wherein the Peltier element is configured to control a temperature in the cavity.

7. The optical measurement system according to claim 5, wherein the Peltier element is configured to control the temperature in the cavity such that the temperature remains essentially constant.

8. The optical measurement systemaccording to claim 5, wherein the Peltier element is attached to a frame which is removably connected to the housing.

9. The optical measurement system according to claim 5, wherein the housing comprises cooling fins.

10. The optical measurement system according to claim 1, wherein the system includes at least one circuit board.

11. The optical measurement system according to claim 1, wherein the system comprises one or more than one thermistor.

12. The optical measurement systemaccording to claim 1, wherein the system comprises a filter configured such that a bandwidth of wavelengths can pass the filter.

13. The optical measurement system according to claim 12, wherein the bandwidth of wavelengths is a main bandwidth of wavelengths of the Fabry-Perot interferometer.

14. The optical measurement system according to claim 12, wherein the bandwidth of wavelengths (λ) is in the wavelength range between λ=1 [μm] and λ=2 [μm], λ=1 [μm] and λ=5 [μm], or λ=1 [μm] and λ=10 [μm].

15. The optical measurement system according to claim 8, wherein the frame and the housing each comprise wedge shaped portions which are form fitting.

16. A method for analyzing the spectrum of an object, the method comprising:
placing an electrically tunable Fabry-Perot interferometer in a path of a radiation emitted by a radiation source in a measurement area,
detecting the radiation by means of a detector, and
controlling an electrically tunable Peltier element which is in thermal connection with the detector and/or interferometer.

17. The method for analyzing the spectrum of an object according to claim 16, wherein the effect of a change in temperature of an environment on mechanical dimensions of the interferometer is compensated by means of the Peltier element.

18. The method for analyzing the spectrum of an object according to claim 16, wherein the Peltier element is controlled such that a temperature of the detector and/or the interferometer remains essentially constant.

19. The method for analyzing the spectrum of an object according to claim 16, wherein the change of a width of a gap of the Fabry-Perot interferometer is less than 0.2 [nm/° C.], less than 0.1 [nm/° C.], or less than 0.05 [nm/° C.] during operation of the optical measurement system 1.

20. A non-transitory computer readable medium having stored thereon a set of computer implementable instructions capable of causing a processor, in connection with an optical measurement system to analyze properties or material contents of a radiation source in a measurement area, the optical measurement system comprising:
an electrically tunable Peltier element,
a deterctor for detecting radiation from a radiation source in a measurement area, the detector being in thernal connection with the Peltier element,
an electrically tunable Fabry-Perot interferometer placed in the path of the radiation prior to the dector, the Fabry-Perot interferometer being in the thermal connection with theh Peltier element, and
control electronics circuitry configured to control the Peltier element, the interferometer, and the detector.
